(19) United States
(12) Patent Application Publication
(10) Pub. No.: US 2010/0053985 A1
(43) Pub. Date: Mar. 4, 2010

(54) VEHICLE INTERIOR LAMP

(76) Inventor: A-Sheng Yang, Taipei Hsien (TW)

Correspondence Address: A-Sheng Yang, 235 Chung - Ho Box 8-24 Taipei, Taiwan, R. O. C., Taipei, TW

(21) Appl. No.: 12/202,440

(22) Filed: Sep. 2, 2008

(51) Int. Cl. B60Q 3/02

(52) U.S. Cl. 362/490; 362/249.07

(57) ABSTRACT

A vehicle interior lamp includes a seat having a sliding groove for buckling a conductive joint assembly; a bottom of the seat being fixed with a lamp panel; the lamp panel installed with at least one light emitting diode; after the light emitting diode being connected to the power wires of the conductive joint assembly, the light emitting diode being fixed to a bottom of the seat; the conductive joint assembly having two ends; one end being a positive electrode end and another end being a negative electrode end; each of the positive electrode end and negative electrode end being extended upwards with a power wire; and the power wires being connected to a light emitting diode of the lamp panel; an elastic unit being installed between the positive electrode end and the negative electrode end. A distance between the positive electrode end and negative electrode end is adjustable.

### FIELD OF THE INVENTION

The present invention relates to lamps, and particularly to a vehicle interior lamp, wherein an elastic unit is installed between a positive electrode end and a negative electrode end so that the positive electrode end and negative electrode end are capable of moving inwards or outwards flexibly; and thus a distance between the positive electrode end and negative electrode end is adjustable.

### BACKGROUND OF THE INVENTION

The vehicle interior lamp is installed at a top end of a vehicle for illumination. Referring to FIG. 1, a perspective view of a prior art vehicle interior lamp is illustrated. A surfaces of the lamp is enclosed with a light emitting diode 31. Two ends of the light emitting diode 31 are extended with a positive electrode end 21 and a negative electrode end 22 which are installed at a top end of an interior of a vehicle. After conduction, the light emitting diode 31 will light up.

However there are various kinds of vehicles. Further one manufacturer has many different types of vehicles with different specification and sizes. Thus the vehicle interior lamps must be designed to have different types from matching the different kinds and types of vehicles. The user must assure the kinds and types of the vehicles for buying a suitable vehicle interior lamp. This is inconvenient for users.

### SUMMARY OF THE INVENTION

Accordingly, the primary object of the present invention is to provide a vehicle interior lamp, wherein an elastic unit is installed between a positive electrode end and a negative electrode end so that the positive electrode end and negative electrode end are capable of moving inwards or outwards flexibly; and thus a distance between the positive electrode end and negative electrode end is adjustable.

To achieve above objects, the present invention provides a vehicle interior lamp, comprising a seat having a sliding groove for buckling a conductive joint assembly; a bottom of the seat being fixed with a lamp panel; the lamp panel installed with at least one light emitting diode; after the light emitting diode being connected to the power wires of the conductive joint assembly, the light emitting diode being fixed to a bottom of the seat; the conductive joint assembly having two ends; one end being a positive electrode end and another end being a negative electrode end; each of the positive electrode end and negative electrode end being extended upwards with a power wire; the power wires being connected to a light emitting diode of the lamp panel; an elastic unit being installed between the positive electrode end and the negative electrode end so that the positive electrode end and negative electrode end are capable of moving inwards or outwards flexibly; and thus a distance between the positive electrode end and negative electrode end is adjustable.

A lower side of each of the positive electrode end and the negative electrode end of the conductive joint assembly is installed with a sliding block for being buckled into the sliding groove of the seat; and the sliding blocks are movable in the sliding groove so that the positive electrode end and the negative electrode end are movable without falling out. After the positive electrode end and the negative electrode end of the conductive joint assembly are conductive, the power wires of the positive electrode end and negative electrode end are connected to the light emitting diode of the lamp panel so that a loop is formed.

The various objects and advantages of the present invention will be more readily understood from the following detailed description when read in conjunction with the appended drawing.

### BRIEF DESCRIPTION OF THE DRAWINGS

FIG. 1 is a perspective view of an inside lamp of a prior art car.

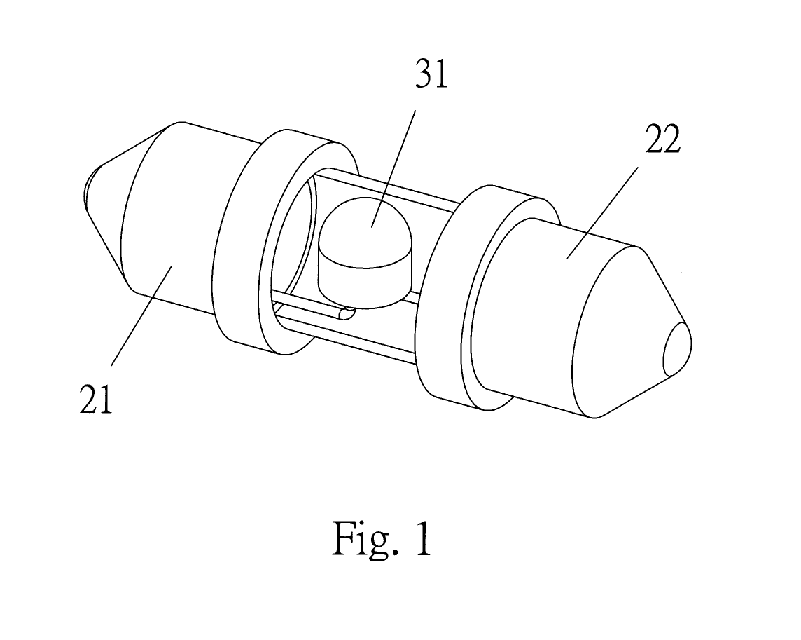

FIG. 2 is an exploded perspective view of the present invention.

FIG. 3 is an assembly perspective view of the present invention.

FIG. 4 shows one operation of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

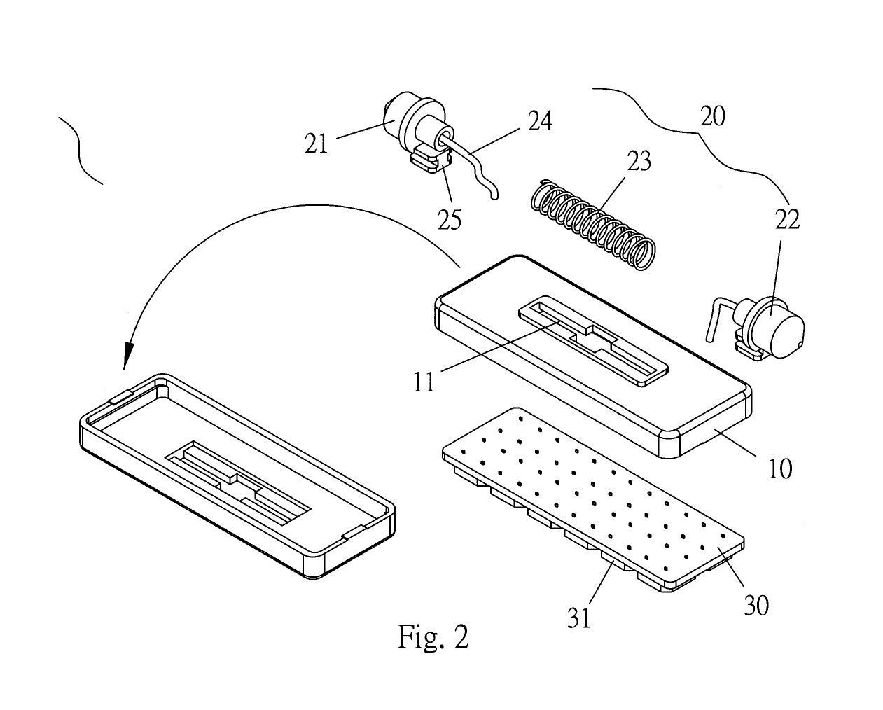

With referring to FIG. 2, the vehicle inside lamp of the present invention is illustrated. The present invention has the following elements.

A seat 10 has a sliding groove 11 for buckling a conductive joint assembly 20. A bottom of the seat 10 is fixed with a lamp panel 30. The seat 10 can be made of plastics so as to install the lamp panel 30 to the seat 10 to provide the effect of insulation. Thus in installing, the worker will not get electric shock.

The lamp panel 30 is installed with at least one light emitting diode 31. After the light emitting diode 31 is connected to the power wires 24 of the conductive joint assembly 20, the light emitting diode 31 is fixed to the bottom of the seat 10.

The conductive joint assembly 20 has two ends. One end is a positive electrode end 21 and another end is a negative electrode end 22. Each of the positive electrode end 21 and negative electrode end 22 is extended upwards with a power wire 24. The power wires 24 are connected to a light emitting diode 31 of the lamp panel 30.

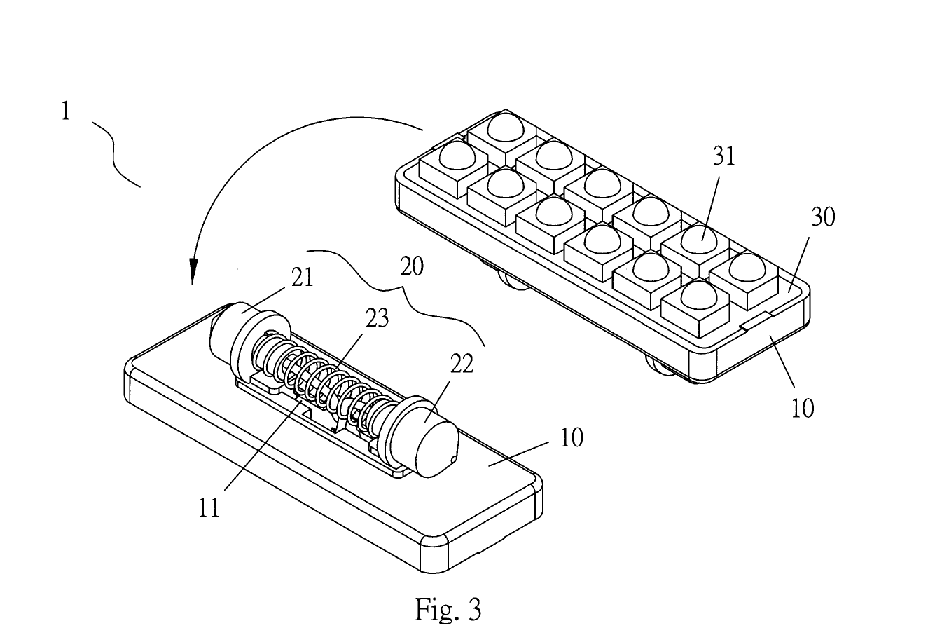

Referring to FIG. 3, an assembly perspective view of the present invention is illustrated. The present invention can be installed at a top end of an interior of a car. An elastic unit 23 is installed between the positive electrode end 21 and the negative electrode end 22 so that the positive electrode end 21 and negative electrode end 22 are capable of moving inwards or outwards flexibly. Thus a distance between the positive electrode end 21 and negative electrode end 22 is adjustable. After the positive electrode end 21 and the negative electrode end 22 of the conductive joint assembly 20 are conductive, the power wires 24 of the positive electrode end 21 and negative electrode end 22 are connected to the light emitting diode 31 of the lamp panel 30 so that a loop is formed. Thus it can light up.

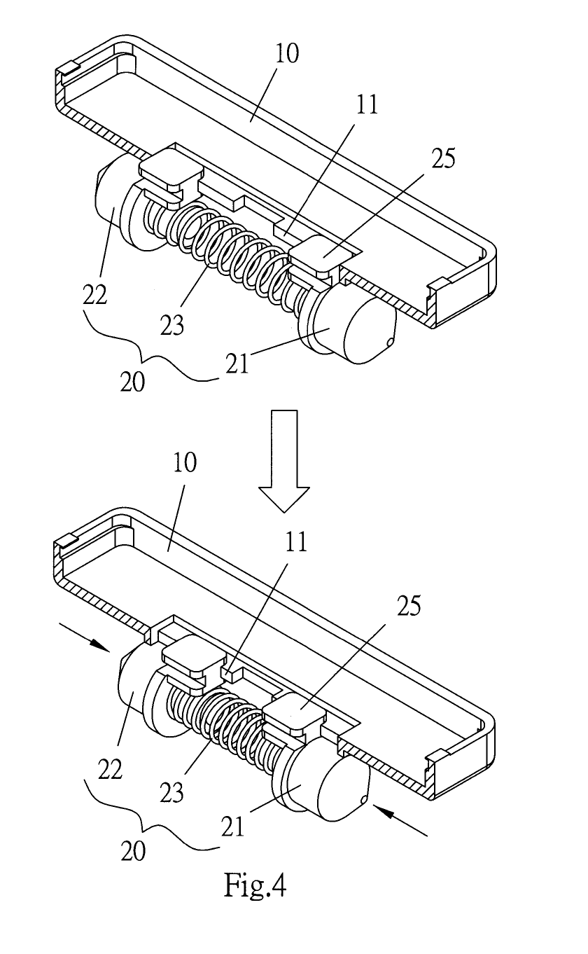

Referring to FIG. 4, one application of the present invention is illustrated. A lower side of each of the positive electrode end 21 and negative electrode end 22 of the conductive joint assembly 20 is installed with a sliding block 25 for being buckled into the sliding groove 11 of the seat 10. The sliding block 25 is movable in the sliding groove 11 so that the positive electrode end 21 and the negative electrode end 22 are movable without falling out. When a pressure is applied from the two sides of the positive electrode end 21 and the negative electrode end 22, the distance between the positive electrode end 21 and negative electrode end 22 will reduce. As the pressure is released, the distance between the positive electrode end 21 and the negative electrode end 22 will restore. In the present invention, the elastic unit 23 may be a spring.

Advantages of the present invention are that the present invention is useful and is suitable for different brands and types. Moreover, the present invention is safe. The seat 10 can be made of plastic and the lamp panel 30 placed upon the seat 10 has the effect of isolation and protection so that the installation can be performed easily with electric shock. The elastic unit 23 placed between the positive electrode end 21 and negative electrode end 22 so that the positive electrode end 21 and negative electrode end 22 are movable inwards or outwards to have the function of adjusting the distance between the positive electrode end 21 and the negative electrode end 22.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A vehicle interior lamp, comprising:
a seat having a sliding groove for buckling a conductive joint assembly; a bottom of the seat being fixed with a lamp panel;
the lamp panel installed with at least one light emitting diode; after the light emitting diode being connected to the power wires of the conductive joint assembly, the light emitting diode being fixed to a bottom of the seat; and
the conductive joint assembly having two ends; one end being a positive electrode end and another end being a negative electrode end; each of the positive electrode end and negative electrode end being extended upwards with a power wire; the power wires being connected to a light emitting diode of the lamp panel; an elastic unit being installed between the positive electrode end and the negative electrode end so that the positive electrode end and negative electrode end are capable of moving inwards or outwards flexibly; and thus a distance between the positive electrode end and negative electrode end is adjustable.

2. The vehicle interior lamp as claimed in claim 1, wherein the elastic unit is a spring.

3. The vehicle interior lamp as claimed in claim 1, wherein a lower side of each of the positive electrode end and the negative electrode end of the conductive joint assembly is installed with a sliding block for being buckled into the sliding groove of the seat; and the sliding blocks are movable in the sliding groove so that the positive electrode end and the negative electrode end are movable without falling out.

4. The vehicle interior lamp as claimed in claim 1, wherein the seat is made of plastics and the lamp panel placed upon the seat has the effect of isolation and protection so that the installation can be performed easily with electric shock.

5. The vehicle interior lamp as claimed in claim 1, wherein after the positive electrode end and the negative electrode end of the conductive joint assembly are conductive, the power wires of the positive electrode end and negative electrode end are connected to the light emitting diode of the lamp panel so that a loop is formed.
